(19) United States
(12) Patent Application Publication
(10) Pub. No.: US 2024/0061761 A1
(43) Pub. Date: Feb. 22, 2024

(54) DEVICE, SYSTEM, AND METHOD FOR TEXT SEMANTIC ANALYSIS USING SOURCE CODE ANALYSIS, AND CHATBOT QUESTION-ANSWER SERVICE PROVIDING METHOD USING SAME

(71) Applicant: LANGCODE INC., Seoul (KR)

(72) Inventors: Min Jun KIM, Seoul (KR); Yun Jae KOH, Seoul (KR); Ji Soo HAN, Seoul (KR)

(21) Appl. No.: 18/384,989

(22) Filed: Oct. 30, 2023

Related U.S. Application Data
(63) Continuation of application No. PCT/KR2022/005901, filed on Apr. 26, 2022.

(30) Foreign Application Priority Data
Sep. 16, 2021 (KR) 10-2021-0123664

(51) Int. Cl. G06F 11/36

(52) U.S. Cl. CPC G06F 11/3608

(57) ABSTRACT

A text semantic analysis method using source code analysis includes receiving, by the server, input data including a text from the terminal, generating, by the server, a text analysis result including semantics of the text by performing natural language processing on the text based on the input data; and generating, by the server, output data corresponding to the semantics of the text based on the text analysis result and providing the output data to the terminal. The generating of the text analysis result includes modifying, by the server, the text by converting a text keyword into source code information corresponding to the text keyword when the text keyword including one or more words included in the text has semantics corresponding to the source code information stored in the server, and generating, by the server, the text analysis result by performing analysis on the modified text.

### CROSS-REFERENCE TO RELATED APPLICATION

This application is a continuation of International Application No. PCT/KR2022/005901 filed on Apr. 26, 2022, which claims priority to Korean Patent Application No. 10-2021-0123664 filed on Sep. 16, 2021, the entire contents of which are herein incorporated by reference.

### BACKGROUND

The present disclosure relates to a device, system, and method for text semantic analysis using source code analysis, and a chatbot question-answer service providing method using the same, and more specifically, to a text semantic analysis device, a text semantic analysis system, and a text semantic analysis method that more accurately analyze not only dictionary semantic analysis on words included in a text, but also semantics of a text based on information obtained by performing source code analysis on words included in the text, and a chatbot question-answer service providing method using the same.

A chatbot refers to an interactive messenger in which, when a question is input to a chatting tool such as a messenger, an artificial intelligence provides an answer to the question as if talking to a person in everyday language. Recently, many domestic and foreign companies have provided 24-hour customer support services and are introducing chatbots to reduce costs and manpower consumed in the customer support services. From the customer's perspective, it is convenient and efficient to obtain necessary knowledge or answers through chatbots, and accordingly, the chatbots are evaluated as improving the quality of the customer support services.

In general, a customer inputs a question to a chatbot via a messenger as if chatting, and the chatbot analyzes text data included in the question and provides an answer corresponding to the question based on the learned data or the data stored in a database. In this case, when commonly used terms are in a question, the chatbot has a high recognition rate therefor and may provide an appropriate answer to the question, but when technical terms are used in a question, an appropriate answer may not be provided.

For example, when a customer inputs a question such as “what is a relationship between a company A and a company B?”, the chatbot may identify the intent of “question on a relationship between specific objects”, search for the relationship between the company A and the company B in the learned data or database, and provide an answer “the relationship is a subsidiary relationship”. However, when a customer in the process of software development inputs a question “what is a relationship between a training channel and a course?” having source code information, and when semantics of the “training channel” and the “course” is not stored in the database used by a chatbot, the semantics of the words are different from the words known to the customer, the chatbot may not provide an appropriate answer to the question.

### SUMMARY

In order to solve the above-described problems, the present disclosure provides a text semantic analysis device, a text semantic analysis system, and a text semantic analysis method that use source code analysis and more accurately analyze not only dictionary semantic analysis on words included in a text, but also semantics of a text based on information obtained by performing source code analysis on words included in the text, and a chatbot question-answer service providing method using the same.

Technical objects to be achieved by the present disclosure are not limited to the above-described technical objects, and other technical objects of the present disclosure may be derived from following descriptions.

An embodiment according to the first aspect of the present disclosure provides a text semantic analysis method using source code analysis based on a communication connection between a terminal and a server. The text semantic analysis method includes receiving, by the server, input data including a text from the terminal, generating, by the server, a text analysis result including semantics of the text by performing natural language processing on the text based on the input data, and generating, by the server, output data corresponding to the semantics of the text based on the text analysis result and providing the output data to the terminal. The generating of the text analysis result includes modifying, by the server, the text by converting a text keyword into source code information corresponding to the text keyword when the text keyword including one or more words included in the text has semantics corresponding to the source code information stored in the server, and generating, by the server, the text analysis result by performing analysis on the modified text.

An embodiment according to the second aspect of the present disclosure provides a question-answer service providing method using source code analysis and a chatbot based on a communication connection between a terminal and a server. The question-answer service providing method includes receiving, by the server, question data including a text from the terminal by using the chatbot, performing, by the server, natural language processing on the text based on the question data by using the chatbot and generating, by the server, a text analysis result including semantics of the text, and generating, by the server, answer data corresponding to the semantics of the text based on the text analysis result by using the chatbot and providing the answer data to the terminal. The performing of the natural language processing includes modifying, by the server, the text by converting a text keyword into source code information corresponding to the text keyword by using the chatbot when the text keyword including one or more words included in the text has semantics corresponding to the source code information stored in the server, and generating, by the server, the text analysis result by performing analysis on the modified text by using the chatbot.

An embodiment according to the third aspect of the present disclosure provides a text semantic analysis system using source code analysis through a communication connection to a terminal. The text semantic analysis system includes a communication module configured to transmit and receive information to and from the terminal, a memory storing a text semantics analysis program, and a processor configured to execute a text semantics analysis program stored in the memory. By executing the text semantics analysis program, the processor receives input data including a text from the terminal through the communication module, generates a text analysis result including semantics of the text by performing natural language processing on the text based on the input data, generates output data corresponding to the semantics of the text based on the text analysis result, and provides the output data to the terminal. When the text keyword including one or more words included in the text has semantics corresponding to the source code information stored in the memory, the processor modifies the text by converting a text keyword into source code information corresponding to the text keyword and generates the text analysis result by performing analysis on the modified text.

An embodiment according to the fourth aspect of the present disclosure provides a text semantic analysis device using source code analysis. The text semantic analysis device includes an input/output module, a memory storing a text semantics extraction program, and a processor configured to execute a text semantics extraction program stored in the memory. By executing the text semantics extraction program, the processor receives input data including a text through the input/output module, generates a text analysis result including semantics of the text by performing natural language processing on the text based on the input data, generates output data corresponding to the semantics of the text based on the text analysis result, and displays the output data on the input/output module. When the text keyword including one or more words included in the text has semantics corresponding to the source code information stored in the memory, the processor modifies the text by converting a text keyword into source code information corresponding to the text keyword and generates the text analysis result by performing analysis on the modified text.

### BRIEF DESCRIPTION OF THE DRAWINGS

Embodiments of the inventive concept will be more clearly understood from the following detailed description taken in conjunction with the accompanying drawings in which:

FIG. 1 is a diagram illustrating a terminal and a text semantic analysis system using source code analysis according to an embodiment of the present disclosure;

FIG. 2 is a block diagram illustrating a configuration of the text semantic analysis system illustrated in FIG. 1;

FIG. 3 is a block diagram illustrating a configuration of the terminal illustrated in FIG. 1;

FIGS. 4 and 5 are diagrams illustrating examples of text semantic analysis using source code analysis and a chatbot, according to an embodiment of the present disclosure;

FIG. 6 is a flowchart illustrating a sequence of a text semantic analysis method using source code analysis, according to another embodiment of the present disclosure;

FIGS. 7 to 10 are flowcharts illustrating detailed steps of some steps of the text semantic analysis method illustrated in FIG. 6;

FIG. 11 is a flowchart illustrating a sequence of a method of providing a question-answer service by using source code analysis and a chatbot, according to another embodiment of the present disclosure; and

FIGS. 12 to 15 are flowcharts illustrating detailed steps of some steps of the method illustrated in FIG. 11.

### DETAILED DESCRIPTION OF THE EMBODIMENTS

Hereafter, the present disclosure will be described in detail with reference to the accompanying drawings. However, the present disclosure may be implemented in many different forms and is not limited to the embodiments described herein. In addition, the accompanying drawings are only for easy understanding of the embodiments disclosed in the present specification, and the technical ideas disclosed in the present specification are not limited by the accompanying drawings. All terms including technical terms and scientific terms used herein should be interpreted as meanings commonly understood by those skilled in the art to which the present disclosure belongs. The terms defined in the dictionary should be interpreted as having additional meanings corresponding to the related technical documents and the currently disclosed content and are not interpreted in a very ideal or limiting sense unless otherwise defined.

In order to clearly describe the present disclosure in the drawings, parts irrelevant to the descriptions are omitted, and a size, a shape, and a form of each component illustrated in the drawings may be variously modified. The same or similar reference numerals are assigned to the same or similar portions throughout the specification.

Suffixes “module” and “unit” for the components used in the following description are given or used interchangeably in consideration of ease of writing the specification, and do not have meanings or roles that are distinguished from each other by themselves. In addition, in describing the embodiments disclosed in the present specification, when it is determined that a detailed descriptions of related known technologies may obscure the gist of the embodiments disclosed in the present specification, the detailed descriptions are omitted.

Throughout the specification, when a portion is said to be “connected (coupled, in contact with, or combined)” with another portion, this includes not only a case where it is “directly connected (coupled, in contact with, or combined)””, but also a case where there is another member therebetween. In addition, when a portion “includes (comprises or provides)” a certain component, this does not exclude other components, and means to “include (comprise or provide)” other components unless otherwise described.

Terms indicating ordinal numbers, such as first and second, used in the present specification are used only for the purpose of distinguishing one component from another component and do not limit the order or relationship of the components. For example, the first component of the present disclosure may be referred to as the second component, and similarly, the second element may also be referred to as the first component. Singular forms used herein should be construed to include plural forms as well, unless clearly indicated to the contrary.

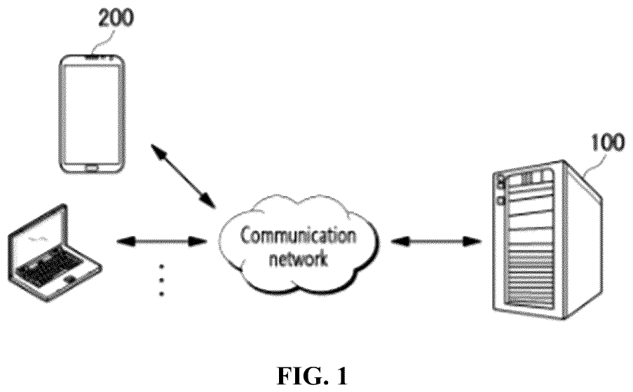

FIG. 1 is a diagram illustrating a terminal 200 and a text semantic analysis system (hereinafter, referred to as a “text semantic analysis system 100”) using source code analysis according to an embodiment of the present disclosure.

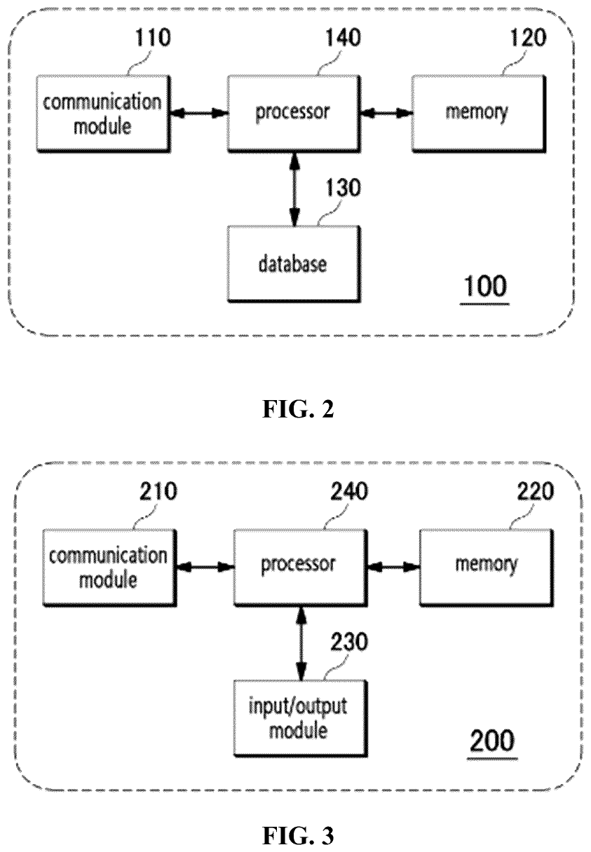

Referring to FIG. 1, the text semantic analysis system 100 is connected to the terminal 200 through a communication network. The text semantic analysis system 100 receives input data including text from the terminal 200 through a communication connection to the terminal 200. The text semantic analysis system 100 performs natural language processing based on the input data and generates a text analysis result. The text semantic analysis system 100 may generate output data corresponding to semantics of a text based on the text analysis result and provide the output data to the terminal 200. The terminal 200 may independently perform the text semantic analysis described above without interaction with the text semantic analysis system 100. For example, the terminal 200 may receive input data including a text from a user through an input/output module, such as a display or a touchpad. The terminal 200 may perform natural language processing based on the input data to generate a text analysis result. The terminal 200 may generate and display output data corresponding to semantics of the text based on the text analysis result. The text semantic analysis system 100 and the terminal 200 may perform the above-described process by using a chatbot. In this case, the input data may be a user's question, and the output data may be a chatbot's answer. A language analysis technology, such as morphological analysis, word analysis, and sentence analysis, may be used for natural language processing of the text semantic analysis system 100 and the terminal 200. The text semantic analysis system 100 and the terminal 200 are described in more detail below with reference to FIGS. 2 and 3.

The text semantic analysis system 100 may be provided in the form of a device, such as a server or the terminal 200, and may operate in a cloud computing service model, such as software as a service (SaaS), platform as a service (PaaS), or infrastructure as a service (IaaS). Also, the text semantic analysis system 100 may be built in the form of a server, such as a private cloud system, a public cloud system, or a hybrid cloud system.

The terminal 200 may refer to a handheld-based wireless communication device, such as a notebook computer equipped with a web browser, a desktop computer equipped with a web browser, a laptop computer equipped with a web browser, a wireless communication device that guarantees portability and mobility, a smartphone, or a tablet personal computer (PC). Also, the communication network illustrated in FIG. 1 may be implemented by a wired network, such as a local area network (LAN), a wide area network (WAN), or a value added network (VAN), or any type of wireless network, such as a mobile radio communication network or a satellite communication network.

FIG. 2 is a block diagram illustrating a configuration of the text semantic analysis system 100. Referring to FIG. 2, the text semantic analysis system 100 may include a communication module 110, a memory 120, a processor 140, and a database 130.

The communication module 110 transmits and receives information to and from the terminal 200. The communication module 110 may include a device including hardware and software required to transmit and receive signals, such as control signals or data signals through a wired or wireless connection to other network devices.

The memory 120 stores a text semantics analysis program. Also, the memory 120 may include source code information including information on one or more programming languages. Here, the source code information may include variable information, class information, function information, and relationship information thereof which are used for one or more programming languages. A name of the text semantics analysis program is set for the sake of convenience of description, and the name itself does not limit functions of the program.

The memory 120 may store at least one of information and data input to the communication module 110, information and data required for functions performed by the processor 140, and data generated by the processor 140. The memory 120 may include a non-volatile storage device that continuously maintains the stored information even when power is not supplied and a volatile storage device that requires power to maintain the stored information. Also, the memory 120 may perform a function of temporarily or permanently storing the data processed by the processor 140. The memory 120 may include magnetic storage media or flash storage media in addition to volatile storage devices that require power to maintain the stored information, but the scope of the present disclosure is not limited thereto.

The database 130 may store data used by the text semantic analysis system 100. For example, the database 130 may store big data and meta information for semantic analysis of input data including a text, such as word semantic information, source code name information, and source code description information. The database 130 may a part of the memory 120 but may be outside the text semantic analysis system 100 without being inside the text semantic analysis system 100.

The processor 140 is configured to execute a text semantics analysis program stored in the memory 120. The processor 140 may include various types of devices that control and process data. The processor 140 may refer to a data processing device built in hardware, which includes a physically structured circuit to perform functions expressed by codes or instructions included in a program. In one example, the processor 140 may include a microprocessor, a central processing unit (CPU), a processor core, a multiprocessor, an application-specific integrated circuit (ASIC), a field programmable gate array (FPGA), or so on, but the scope of the present disclosure is not limited thereto.

The processor 140 is configured to execute a text semantics analysis program and perform following functions and procedures. The processor 140 may receive input data including a text from the terminal 200 through the communication module 110, perform natural language processing on the text based on the input data to generate a text analysis result including semantics of the text, generate output data corresponding to the semantics of the text based on the text analysis result, and provide the output data to the terminal 200. When a text keyword including one or more words included in a text has semantics corresponding to source code information stored in the memory 120, the processor 140 may modify the text by converting the text keyword into source code information corresponding to the text keyword and perform analysis of the modified text, thereby generating a text analysis result. In one example, the text may include question information, the text analysis result may include function information for generating an answer corresponding to the question information of the text, and the output data may include answer information generated according to the function information. Also, the text keyword may be composed of words with source code semantics, such as a “training channel” and a “course”, and the source code keyword may be composed of a “training channel” and a “course” respectively corresponding to a “training channel ( [symbol] )” and a “course ( [symbol] )”.

The processor 140 may extract nouns included in variable information, class information, and function information used for one or more programming languages and set the nouns as source code keywords. In addition, the processor 140 may generate source code information based on a name of a source code corresponding to the source code keyword, an abbreviation of the source code, and a relationship between the translation of the source code and the source code keyword, and store the source code information in the memory 120.

The processor 140 may determine whether a source code keyword corresponding to a text keyword is present in the memory 120. The processor 140 may perform semantic analysis on a text keyword including a corresponding source code keyword stored in the memory 120 among the text keywords included in a text, based on semantics of the source code keyword corresponding to the text keyword. The processor 140 may perform semantic analysis on text keywords not including a corresponding source code keyword, based on dictionary semantics.

The processor 140 may set the intent of a text as one of preset intent types, based on a text analysis result including semantics of the text. The processor 140 may set the entity of a text as one of preset entity types, based on the text analysis result including semantics of the text. Here, the preset intent types may include a function check type and an error report type, but the scope of the present disclosure is not limited thereto, and the intent types may be set in various ways. The preset entity types may include a function description type and an error description type, but the scope of the present disclosure is not limited thereto, and the entity types may be set in various ways.

In one example, when a text keyword including one or more words included in a text has semantics corresponding to a plurality of pieces of source code information stored in the memory 120, the processor 140 may provide the plurality of pieces of source code information to the terminal 200. Next, the processor 140 may receive an input for one piece of source code information among the plurality of pieces of source code information from the terminal 200. Next, the processor 140 may convert a text keyword into source code information received from the terminal 200, modify the text, and perform analysis on the modified text, thereby generating a text analysis result.

FIG. 3 is a block diagram illustrating a configuration of the terminal 200 illustrated in FIG. 1. Referring to FIG. 3, the terminal 200 may include a memory 220, an input/output module 230, a processor 240, and a communication module 210.

The communication module 210 may transmit and receive information to and from an external database or an external device. Here, the external device may be the text semantic analysis system 100 (illustrated in FIG. 1) described above. The memory 220 stores a text semantics extraction program. A name of the text semantics extraction program is set for the sake of convenience of description, and the name itself does not limit a function of the program. The memory 220 may include source code information including information on one or more programming languages. The source code information may include variable information, class information, function information, and relationship information thereof which are used for one or more programming languages. The input/output module 230 may receive information or data transmitted to the terminal 200 from the outside, or may output information or data included in the terminal 200 to the outside. For example, the input/output module 230 may include a display, a touch pad, and so on. The processor 240 executes the text semantics extraction program stored in the memory 220. Additional descriptions on the communication module 210, the memory 220, and the processor 240 may be replaced with the descriptions on the communication module (110 illustrated in FIG. 2), the memory (120 illustrated in FIG. 2), and the processor (140 illustrated in FIG. 2), which are previously given with reference to FIG. 2.

The processor 240 is configured to execute the text semantics extraction program and perform following functions and procedures. The processor 240 may receive input data including a text through the input/output module 230, perform natural language processing on the text based on the input data, generate a text analysis result including text semantics, generate output data corresponding to the text semantics based on the text analysis result, and display the output data on the input/output module 230. When a text keyword including one or more words included in a text has semantics corresponding to source code information stored in the memory 120, the processor 240 may modify the text by converting the text keyword into source code information corresponding to the text keyword and perform analysis of the modified text, thereby generating a text analysis result. In one example, the text may include question information, the text analysis result may include function information for generating an answer corresponding to the question information of the text, and the output data may include answer information generated according to the function information.

The processor 240 may extract nouns included in variable information, class information, and function information used for one or more programming languages and set the nouns as source code keywords. In addition, the processor 240 may generate source code information based on a name of a source code corresponding to the source code keyword, an abbreviation of the source code, and a relationship between the translation of the source code and the source code keyword, and store the source code information in the memory 220.

The processor 240 may determine whether a source code keyword corresponding to a text keyword is present in the memory 220. The processor 240 may perform semantic analysis on a text keyword including a corresponding source code keyword stored in the memory 220 among the text keywords included in a text, based on semantics of the source code keyword corresponding to the text keyword, and perform semantic analysis on text keywords not including a corresponding source code keyword, based on dictionary semantics.

The processor 240 may set the intent of a text as one of preset intent types, based on a text analysis result including semantics of the text, and set the entity of a text as one of preset entity types, based on the text analysis result including semantics of the text. Here, the preset intent types and entity type are respectively the same as the preset intent types and entity types described above with reference to FIG. 2, and accordingly, descriptions thereof are omitted. when a text keyword including one or more words included in a text has semantics corresponding to a plurality of pieces of source code information stored in the memory 220, the processor 240 may display the plurality of pieces of source code information on the input/output module 230. Hereinafter, the processor 240 may receive an input for one piece of source code information among the plurality of pieces of source code information through the input/output module 230, convert a text keyword into the received source code information, modify the text, and perform analysis on the modified text, thereby generating a text analysis result.

The source code information used by the text semantic analysis system 100 and the terminal 200 may be generated by a following method. For example, data provided to the text semantic analysis system 100 by a user that inputs a text through the terminal 200, source code information, and data linked to and collected from a platform that performs text semantic analysis may be stored in the memory 120 or the database 130. Accordingly, metadata and big data on source code information may be collected. Also, the text semantic analysis system 100 may extract elements, such as a variable, a class (object), and a function (method) used for the collected programming languages, a relationship between the elements, and a structure, and store the elements, relationship, and structure as source code information. Also, the text semantic analysis system 100 may perform machine translation on the stored information, match information on the translated text with an original text, and store the matching result. The terminal 200 may also generate and store source code information through a process similar to the process described above.

More specifically, the text semantic analysis system 100 may store nouns (names), which are extracted from source codes, such as a variable name, a class name, and a function name that are used for the above-described programming languages to generate source code information as one source code keyword. Here, nouns and so on, which are low in importance or temporarily used, may be excluded in consideration of the type of noun (whether the name is a variable name, a class name, or so on), the frequency of use in the source code, an exception rule, and so on. For example, nouns of combinations of alphabets and numbers, which are generally and temporarily used by programmers, such as “a”, “I”, “j”, “t”, “temp”, “tmp”, “a1”, and “t1”, specific codes such as Main( ), function names provided by default in frameworks, and so on may be excluded from keywords. Also, a class name is set as a keyword when used once and does not correspond to an exception rule, and a variable may not be set as the keyword, when a corresponding noun is used once and is not reused. For example, when there is a class called “TrainingChannel”, the text semantic analysis system 100 may register the “TrainingChannel” as a source code keyword. The text semantic analysis system 100 may generally distinguish Naming convention generally used for source codes, that is, upper case letters and lower case letters, such as camelCase, PascalCase, Kebab-case, and Snake_case, or special characters, such as “_”, “-”, “/”, “:”, and “.”, and segment a continuous string Name without spaces. For example, “TrainingChannel” may be modified to “Training channel”, and “lastlogin” may be modified to “last login”. The text semantic analysis system 100 may additionally perform the segmentation and modification by utilizing abbreviations, initials, and patterns commonly used for codes, and patterns stored in the known knowledge graphs. For example, “Tmpl” may be modified to “Template”, “Cnt” may be modified to “Count”, “StudentNum” may be modified to “Student Number” & “The number of studnet”, and “SchoolList” may be modified to “School List” & “The list of school”. The text semantic analysis system 100 may perform translation of the segmented keywords by considering question-answer languages of a chatbot. For example, when the text semantic analysis system 100 uses a Korean chatbot, “StudentCard” may be transformed into “Student card” and “student card ( [symbol] )”, and “SchoolList” may be transformed into “school list ( [symbol] )”.

The text semantic analysis system 100 may determine a relationship between extracted nouns (keywords) from structures of codes, and so on. Relationships between programming languages may include attributes, declarations, references, operations, and so on. The attributes may refer to a case where a variable or function is declared in a specific class. For example, when the User class has Name and Email variables, relationships, such as “User-Name” and “User-Email”, may refer to the properties. The text semantic analysis system 100 may express the relationship by using “,” with respect to attributes, or input the attributes as a source code keyword. For example, when the student class has a Name variable, the student class may be expressed as “Student.Name”. A source code keyword for “Student.Name” may be set as “Student name” and may be transformed into “The name of student”, “Student name”, or “Student's name”. The declaration refers to a case where a new variable is declared in a specific function. For example, when “newUser”, “userAddResult”, and so on are declared in a function called “AddNewUser”, the relationship, such as “AddNewUser-newUser” or “AddNewUser-userAddResult”, may mean a declaration relationship. The reference refers to a case where there is a reference, such as calling another variable or function in a specific function. For example, when a function “GetStudentName” refers to Name attributes (variables) of a student class, a relationship, such as “GetStudentName-Student.Name”, may mean a reference relationship. The operation refers to a case where variables are used together as operands of a specific operation, such as comparison or four arithmetic operations. For example, when there is a comparison operation called “minScore>student.Score” in a code, a relationship, such as “minScore−Student.Score”, may mean an operation relationship.

The relationship described above is not fixed, and there also may be multiple relationships even between the same nouns (keywords). Also, there may be not only direct primary relationships, but also secondary and tertiary relationships based thereon. This relationship may be used for keyword extraction, intent type setting, entity type setting, and so on when text included in input data are analyzed by the text semantic analysis system 100 and the terminal 200. For example, when there is a function called “GetStudentNames” in a school class, and when this function refers to a variable (attributes) called Name of the Student class, a following relationship may be set. That is, “School-GetStudentNames” may be inferred to be attributes as a primary relationship, “GetStudentNames-Student.Name” may be inferred to be a reference as a primary relationship, and “School-Student.Name” may be inferred to be attributes and reference relationships as a secondary relationship. Alternatively, “Student.Name” may be regarded as an attribute relationship like “Student-Name”, and then “School-Name” may be inferred to be attributes, a reference, and an attribute relationship as a tertiary relationship.

Also, the text semantic analysis system 100 and the terminal 200 may perform text semantic analysis and output data generation through a following process. For example, the text semantic analysis system 100 may perform morphological analysis on a text included in input data transmitted from the terminal 200 by using a chatbot. Here, the text may be in the form of a question. The text semantic analysis system 100 may improve a problem of low accuracy of the above-described morphological analysis due to words not in a dictionary by using source code information. The text semantic analysis system 100 may extract intent and entity of a user's query based on sentence structure analysis and pattern matching by using a morphological analysis result using source code information. The text semantic analysis system 100 may increase analysis accuracy by performing sentence structure analysis and pattern matching again on the extracted entity. Here, the text semantic analysis system 100 may perform processing, such as translation and conversion, to match the source code when a language used through a chatbot is not English. The text semantic analysis system 100 may transform input data in accordance with predefined interfaces, specifications, and formats such that an algorithm, a program, and so on that will process actual questions and answers may understand the input data based on the extracted intent and entity. Here, the intent may be used as a function (method) to be requested, and the entity may be used as a variable. When a variable and so on that have to be included in the transformed input data are missing, the text semantic analysis system 100 may request information on the variable from the terminal 200 through a chatbot message. The terminal 200 may also perform text semantic analysis and output data generation through a process similar to the process described above.

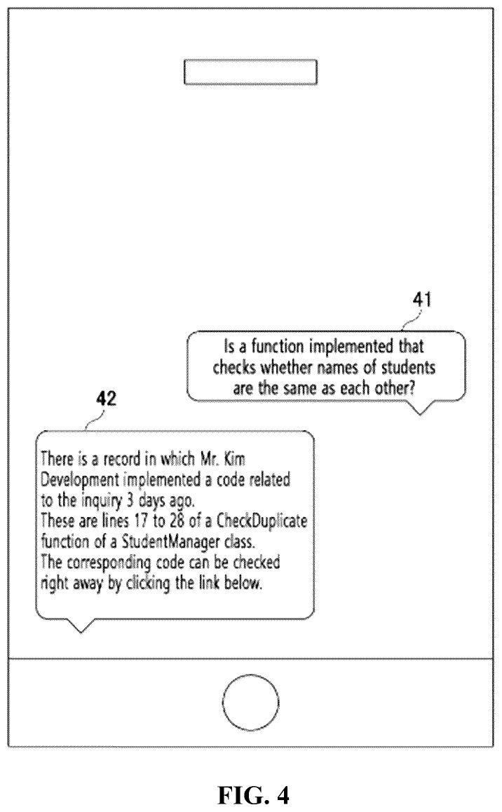

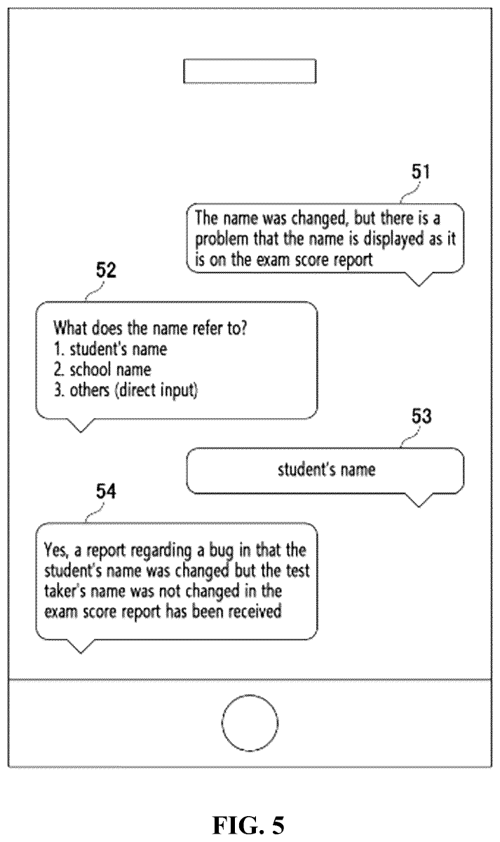

FIGS. 4 and 5 are diagrams illustrating examples of analyzing text semantics by using source code analysis and a chatbot, according to an embodiment of the present disclosure. Hereinafter, the text semantic analysis and output data generation process described above are described in more detail with reference to FIGS. 4 and 5 along with FIGS. 1 to 3.

Referring to FIG. 4, a user who wants to ask a question about a source code may ask a question 41 “Is a function implemented that checks whether names of students are the same as each other?” through the terminal 200 or a chatbot by transmitting input data to the text semantic analysis system 100. The chatbot may extract a text keyword included in the question and search whether a source code keyword according to source code information matching the text keyword is stored in the text semantic analysis system 100 or the terminal 200. Here, the chatbot may perform the same function as a processor of the text semantic analysis system 100 or the terminal 200.

The chatbot may check a Name variable (attributes) of a student class by checking that a text keyword “student's name” matches a source code keyword “Student.Name”. Accordingly, the chatbot may convert the question into “Is there a function implemented to check whether there is a case in which {Student.Name} is the same?”. The chatbot may perform morphological analysis and sentence structure analysis on the converted question. Based on an analysis result, the chatbot may select the intent that best matches the user's question from patterns and example utterance records of intents previously trained by the chatbot. The chatbot may set the intent type to “function implementation check”, and set the entity type to “function description”. The chatbot may identify a user's intent, such as “Check whether there is a case where {Student.Name} is the same” from the entity type. The chatbot may additionally perform morphological analysis and sentence structure analysis on additionally extracted entity. The chatbot may identify a relationship and a correlation between source codes, such as (operation), (operation/match), and (reference/if) from the entity. The chatbot may translate general morphemes and words, such as “equal ( [symbol] )”, “case ( [symbol] )”, “exist(present) ( [symbol] ))”, and “check ( [symbol] )”, into “equal”, “case”, “check”, “compare”, and “exist” through translation. In this case, content not stored as source code information may be interpreted as dictionary semantics.

In the above example, in order to generate an answer to a user's question, the processor 140 of the text semantic analysis system 100 may request the chatbot to transmit function information having a format, such as checkFeature (“variable or class name”, “relevant relationship list”, or “word used for feature description”). The chatbot may match the extracted and converted information to the above format and transmit, to the processor 140, function information, such as checkFeature (“Student.Name”, “(operation), (operation/match), (reference/if)”, “equal, case, exist, check, equal, case, check, compare, exist”). That is, in response to a user's input “Is a function implemented that checks whether names of students are the same as each other?”, the chatbot may transmit, to the processor 140, a text analysis result, such as checkFeature (“Student.Name”, “(operation), (operation/match), (reference/if)”, “equal, case, exist, check, equal, case, check, compare, exist”). The processor 140 may generate an answer 42, such as “There is a record in which Mr. Kim Development implemented a code related to the inquiry 3 days ago. These are lines 17 to 28 of a CheckDuplicate function of a StudentManager class. The corresponding code can be checked right away by clicking the link below.” according to the function information received from the chatbot. In other words, the processor 140 may complete output data including the answer 42 corresponding to a user's question based on the text analysis result and transmit the output data to the terminal 200 through the chatbot.

Referring to FIG. 5, a user who wants to ask a question about a source code may ask a question 51 “the name was changed, but there is a problem that the name is displayed as it is on the exam score report” through the terminal 200 or a chatbot by transmitting input data to the text semantic analysis system 100. The chatbot may convert a question by checking a keyword “exam score report”−“ExamResult” from the source code information stored in the text semantic analysis system 100 or the terminal 200. The chatbot may extract “name”, “change”, “from”, “as it is”, “display”, “problem”, “there is/are”, and so on through morphological analysis. In order to identify what corresponds to a source code for a noun “name”, the chatbot may expand a relationship between pieces of source code information to the second and third relationships to search for a variable name, a class name, and so on that match or are similar to “Name”.

For example, as a search result, the chatbot may check that a function “ShowStudentExamResult” includes an assignment operation called “examResult.Examinee=student.Name” in the following relationship.

ExamResult.Examinee−Student.Name(operation)

ExamResult−Examinee(attributes),Student−Name(attributes)

Additionally, the chatbot may check that the corresponding function includes an assignment operation called “examResult.Cohort=school.Name”. The chatbot may check that a relationship degree of ExamResult and Student.Name is 3 from ExamResult−Examinee-Name-Student. The chatbot may identify that a relationship degree of ExamResult and School.Name is 3 from ExamResult−Cohort-Name-School. Because a search result other than the above description exceeds a relationship degree of 10, the chatbot may only determine an actual related relationship based on the above description.

Because the chatbot may not determine which of attribute values of “name” included in Student.Name and School.Name is indicated by a noun “name”, the chatbot may ask a user, through the terminal 200, what the “name” specifically refers to through a phrase and a response button. For example, the chatbot may display a message 52 below on the terminal 200.

“What does the name refer to?
Button 1: student's name
Button 2: school name
Button 3: others (direct input)”

When a user clicks button 1 in the terminal 200 and makes a response 53 “student's name”, the chatbot may convert the user's question into “{Student.Name} was changed, but there is a problem that {ExamResult.Examinee} is displayed as it is”. Originally, an “exam score report” may be replaced with “ExamResult”, but the chatbot may check in the search result that what the user indicates is specifically “ExamResult.Examinee” not “ExamResult.Cohort” and utilize the check result.

The chatbot may identify the most matching intent by performing morphological analysis and sentence structure analysis about the converted question. For example, the chatbot may set an intent type of the question as “bug, error report” and set an entity type as a problem description entity. Based on a corresponding entity type, the chatbot may extract an entity “{Student.Name} was changed, but display {ExamResult.Examinee} as it is”.

The chatbot may additionally perform morphological analysis and sentence structure analysis on entities to extract a relationship between (operation), (operation/assignment), and so on, and “change”, “as it is”, and “display”, and change, edit, same, display, unchanged, and so on converted and derived therefrom. The processor 140 may request the chatbot to transmit function information, such as reportBug (“variable or class name”, “relationship list”, “word, morpheme”). As a result, based on the input “the name was changed, but there is a problem that the name is displayed in the exam score report as it is”)”, the chatbot may generate a text analysis result including the function information called reportBug(“Student.Name, ExamResult.Examinee”, “(operation), (operation/assignment)”, “change, as it is, edit, same, display, unchanged”), and transmit the text analysis result to the processor 140. The processor 140 may generate an answer 54, such as “Yes, a report regarding a bug in that the student's name was changed but the test taker's name was not changed in the exam score report has been received” according to the function information transmitted from the chatbot. In other words, the processor 140 may complete output data including the answer 54 corresponding to a user's question based on the text analysis result and transmit the output data to the terminal 200 through the chatbot.

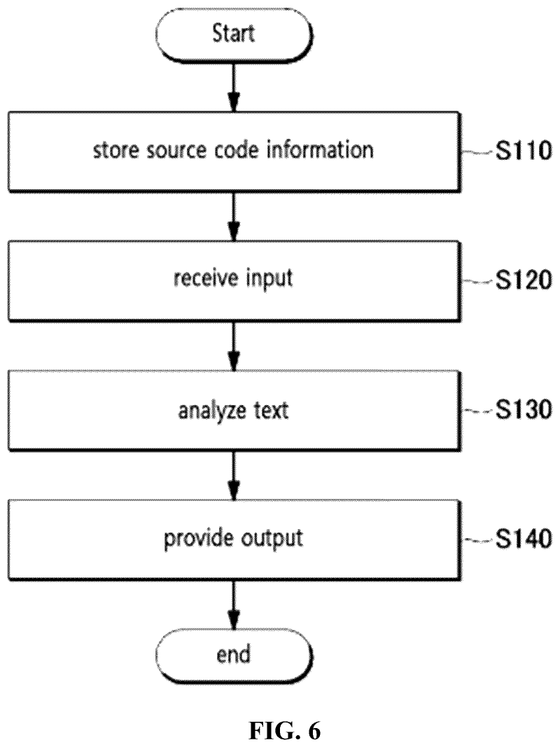

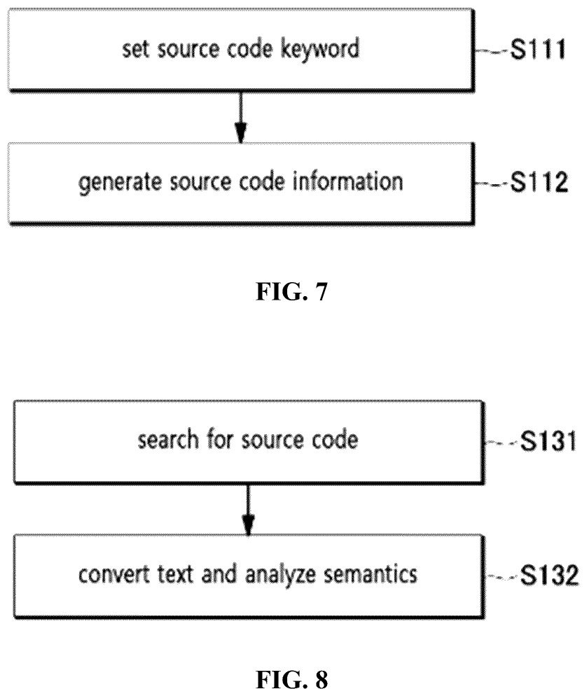

FIG. 6 is a flowchart illustrating a sequence of a text semantic analysis method using source code analysis, according to another embodiment of the present disclosure, and FIGS. 7 to 10 are flowcharts illustrating detailed steps of some steps of the text semantic analysis method illustrated in FIG. 6. A text semantic analysis method using source code analysis to be described below may be performed by at least one of the text semantic analysis system 100 illustrated in FIG. 1 using the source code analysis described above with reference to FIGS. 1 to 5 and the terminal 200 illustrated in FIG. 1. Accordingly, the descriptions of the embodiments of the present disclosure described above with reference to FIGS. 1 to 5 may be applied to embodiments to be described below in the same manner as described above, and redundant descriptions of the embodiments to be described below are omitted. Steps to be described below do not have to be sequentially performed, and a sequence of the steps may be set in various ways, and the steps may also be performed almost simultaneously.

Referring to FIG. 6, the text semantic analysis method using source code analysis may be performed through a communication connection between a terminal and a server and may include an input receiving step S120, a text analysis step S130, and an output providing step S140 and may further include a source code information storage step S110. Here, the server may be the text semantic analysis system 100 illustrated in FIG. 1 which uses the source code analysis described above, and the terminal may be the terminal 200 illustrated in FIG. 1 described above.

The source code information storage step S110 is a step of generating source code information and storing the source code information in a memory of the server. As such, the server may include a memory storing source code information including information on one or more programming languages. The source code information may include variable information, class information, function information, and relationship information thereof, which are used for one or more programming languages.

The input receiving step S120 is a step of receiving input data including a text from the terminal, and the text analysis step S130 is a step of generating a text analysis result including semantics of the text as the server performs natural language processing on the text based on the input data. The text analysis step S130 may include a step in which, when a text keyword including one or more words included in the text has semantics corresponding to the source code information stored in the server, the server converts the text keyword into source code information corresponding to the text keyword, modifies the text, performs analysis on the modified text, and generates a text analysis result. The output providing step S140 is a step in which the server generates output data corresponding to the semantics of the text based on the text analysis results and provides the output data to the terminal. In one example, the text may include question information, the text analysis result may include function information for generating an answer corresponding to the question information of the text, and the output data may include answer information generated according to the function information.

Referring to FIG. 7, the source code information storage step S110 may include a source code keyword setting step S111 and a source code information generation step S112. The source code keyword setting step S111 may include a step in which a server extracts nouns included in variable information, class information, and function information that are used for one or more programming languages and setting the nouns as source code keywords. The source code information generation step S112 may include a step in which the server generates source code information based on names of source codes corresponding to the source code keywords, an abbreviation of the source code, and a relationship between the translation of the source code and the source code keywords and stores the source code information in a memory.

Referring to FIG. 8, the text analysis step S130 may include a source code search step S131 and a text conversion and semantic analysis step S132. The source code search step S131 refers to a step in which the server determines whether a source code keyword corresponding to a text keyword is in a memory. The text conversion and semantic analysis step S132 may refer to a step in which the server performs semantic analysis on a text keyword including a corresponding source code keyword stored in the memory among text keywords included in the text, based on semantics of a corresponding source code keyword, and performs semantic analysis on the text keyword not including a corresponding source code keyword based on dictionary semantics. Descriptions of the text keyword and source code keyword are described above with reference to FIGS. 1 to 5, and accordingly, the descriptions are omitted below.

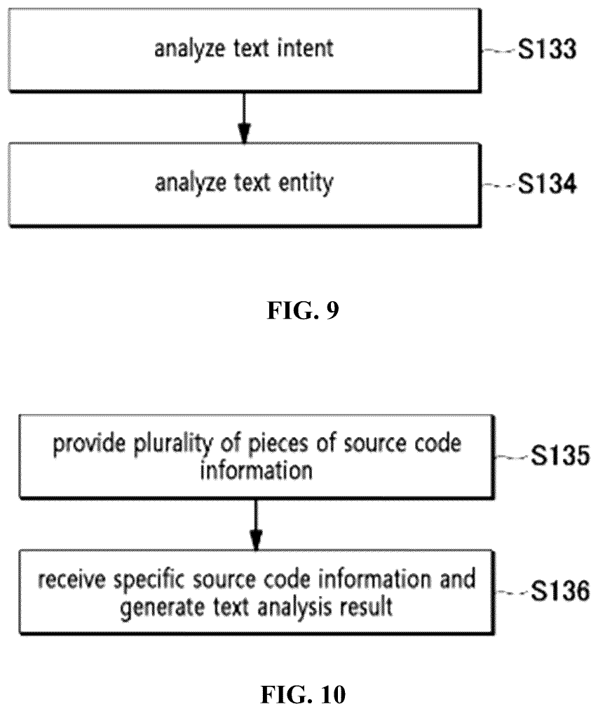

Referring to FIG. 9, the text analysis step S130 may include a text intention analysis step S133 and a text entity analysis step S134. The text intent analysis step S133 may include a step in which a server sets the intent of a text to one of preset intent types based on a text analysis result including semantics of the text. The text entity analysis step S134 may include a step in which the server sets the entity of a text to one of preset entity types based on the text analysis result including semantics of the text. The preset intent types and entity types are substantially the same as the intent types and entity types previously described with reference to FIGS. 1 to 5, and accordingly, descriptions thereof are omitted.

Referring to FIG. 10, the text analysis step S130 may include step S135 of providing a plurality of pieces of source code information and step S136 of receiving specific source code information and analyzing a text. Step S135 of providing the plurality of pieces of source code information refers to a step in which, when a text keyword including one or more words included in a text has semantics corresponding to the plurality of pieces of source code information stored in a server, the server provides the plurality of pieces of source code information to a terminal. Step S136 of receiving the specific source code information and analyzing a text refers to a step in which the server receives an input for one piece of source code information among the plurality of pieces of source code information from the terminal, converts a text keyword into the source code information received from the terminal, modifies the text, analyzes the modified text, and generates a text analysis result.

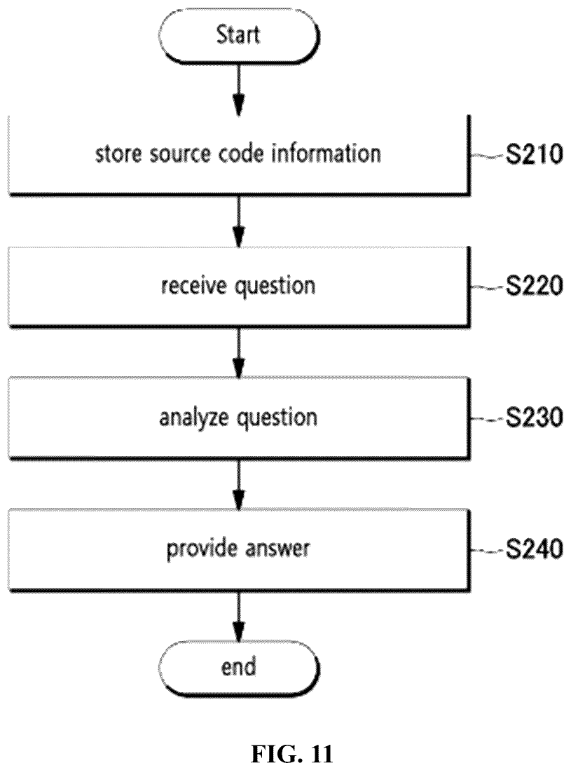

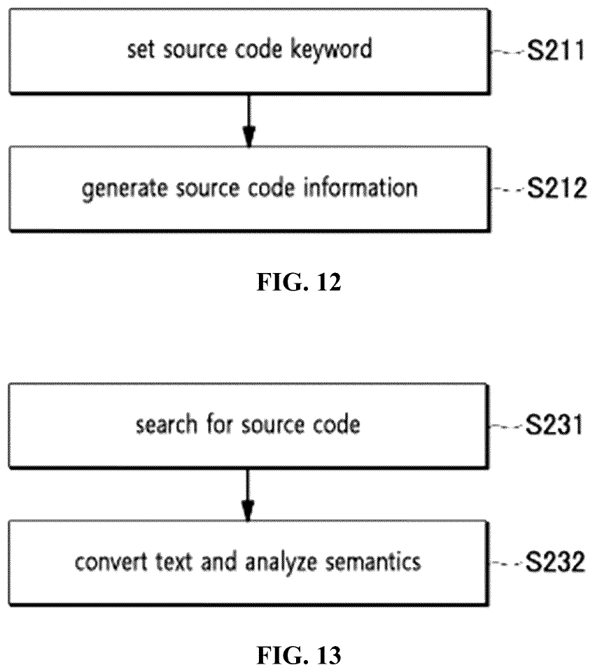

FIG. 11 is a flowchart illustrating a sequence of a method of providing a question-answer service by using source code analysis and a chatbot, according to another embodiment of the present disclosure, and FIGS. 12 to 15 are flowcharts illustrating detailed steps of some steps of the method illustrated in FIG. 11. The method of providing a question-answer service by using source code analysis and a chatbot to be described below may be performed by at least one of the text semantic analysis system 100 illustrated in FIG. 1 and the terminal 200 illustrated in FIG. 1 using the source code analysis described above with reference to FIGS. 1 to 5. Accordingly, the descriptions of the embodiments of the present disclosure described above with reference to FIGS. 1 to 5 may be applied to embodiments to be described below in the same manner as described above, and redundant descriptions of the embodiments to be described below are omitted. Steps to be described below do not have to be sequentially performed, and a sequence of the steps may be set in various ways, and the steps may also be performed almost simultaneously.

Referring to FIG. 11, the method of providing a question-answer service by using source code analysis and a chatbot may include a source code question receiving step S220, a question analysis step S230, and an answer providing step S240, and may further include a source code information storage step S210.

The source code information storage step S210 is a step in which a server generates source code information and stores the source code information in a memory of the server. In this way, the server may include the memory storing source code information including information on one or more programming languages, and the source code information may include variable information, class information, function information, and relationship information thereof, which are used for one or more programming languages.

The question receiving step S220 is a step in which the server receives question data including a text from a terminal by using a chatbot. The question analysis step S230 is a step in which the server performs natural language processing on the text based on the question data by using the chatbot and generates a text analysis result including semantics of the text. The answer providing step S240 is a step in which the server generates answer data corresponding to the semantics of the text based on the text analysis results by using the chatbot and provides the answer data to the terminal. The question analysis step S230 may include a step in which, when a text keyword including one or more words included in the text has semantics corresponding to the source code information stored in the server, the server modifies the text by converting the text keyword into source code information corresponding to the text keyword by using the chatbot, and generates a text analysis result by performing analysis on the modified text by using the chatbot. In one example, the text may include question information, the text analysis result may include function information for generating an answer corresponding to the question information of the text, and the output data may include answer information generated according to the function information.

Referring to FIG. 12, the source code information storage step S210 may include a source code keyword setting step S211 and a source code information generation step S212. The source code keyword setting step S211 may include a step in which a server extracts nouns included in variable information, class information, and function information that are used for one or more programming languages and setting the nouns as source code keywords. The source code information generation step S212 may include a step in which the server generates source code information based on names of source codes corresponding to the source code keywords, an abbreviation of the source code, and a relationship between the translation of the source code and the source code keywords and stores the source code information in a memory.

Referring to FIG. 13, the question analysis step S230 may include a source code search step S231 and a text conversion and semantic analysis step S232. The source code search step S231 refers to a step in which the server determines whether a source code keyword corresponding to a text keyword is in a memory. The text conversion and semantic analysis step S232 may refer to a step in which the server performs semantic analysis on a text keyword including a corresponding source code keyword stored in the memory among text keywords included in the text, based on semantics of a corresponding source code keyword, and performs semantic analysis on the text keyword not including a corresponding source code keyword based on dictionary semantics.

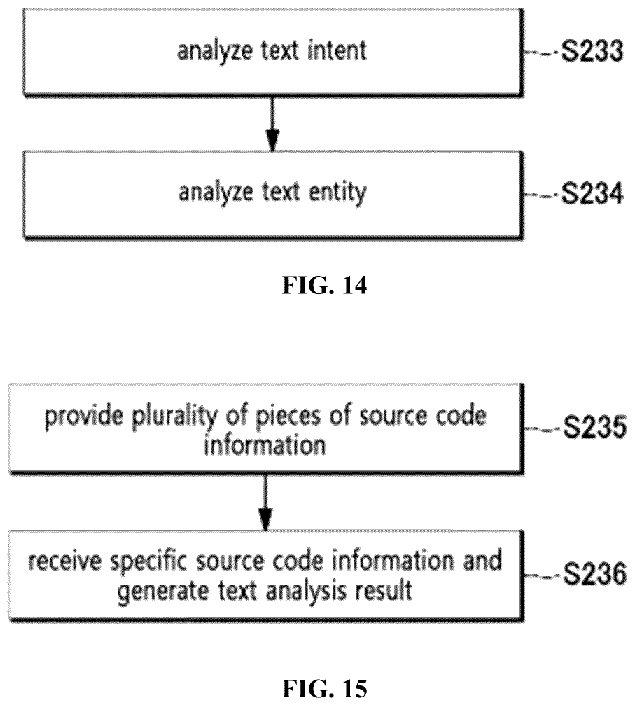

Referring to FIG. 14, the question analysis step S230 may include a text intent analysis step S233 and a text entity analysis step S234. The text intent analysis step S233 may include a step in which a server sets the intent of a text to one of preset intent types based on a text analysis result including semantics of the text. The text entity analysis step S234 may include a step in which the server sets the entity of a text to one of preset entity types based on the text analysis result including semantics of the text. The preset intent types and entity types are substantially the same as the intent types and entity types previously described with reference to FIGS. 1 to 5, and accordingly, descriptions thereof are omitted.

Referring to FIG. 15, the question analysis step S230 may include step S235 of providing a plurality of pieces of source code information and step S236 of receiving specific source code information and generating a text analysis result. Step S235 of providing the plurality of pieces of source code information refers to a step in which, when a text keyword including one or more words included in a text has semantics corresponding to the plurality of pieces of source code information stored in a server, a server provides the plurality of pieces of source code information to a terminal by using a chatbot. Step S236 of receiving specific source code information and generating a text analysis result refers to a step in which the server uses a chatbot to receive an input for one piece of source code information among the plurality of pieces of source code information from the terminal, convert a text keyword into the source code information received from the terminal, modify the text, analyze the modified text, and generate a text analysis result.

The text semantic analysis method using source code analysis and the method of providing a question-answer service using source code analysis and a chatbot, according to embodiments of the present disclosure described above may also be implemented in the form of a recording medium, which includes instructions executable by a computer, such as a program module executed by the computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable instructions, data structures, program modules or other data.

According to the present disclosure, semantics of a text may be analyzed more accurately by performing not only dictionary semantic analysis but also source code analysis about words included in the text.

Also, according to the present disclosure, when words included in the text are not included in a dictionary in a process in which a question-answer type chatbot performs text semantic analysis, source code analysis for the words may be performed to increase a degree of understanding of a question and to provide an appropriate answer to the question.

Those skilled in the technical field to which the present disclosure belongs will be able to understand that the present disclosure may be easily modified into other specific forms based on the above description without changing the technical idea or essential features of the present disclosure. Therefore, the embodiments described above should be understood in all respects as illustrative and not restrictive. The scope of the present disclosure is indicated by the patent claims to be described below, and all changes or modified forms derived from the meaning and scope of the claims and their equivalent concepts should be construed as being included in the scope of the present disclosure. The scope of the present application is indicated by the claims to be described below rather than the detailed description above, and all changes or modified forms derived from the meaning and scope of the claims and their equivalent concepts should be construed as being included in the scope of the present application.

The form for implementing the invention is substantially the same as the previous best form for implementing the invention.

The present disclosure has industrial applicability because the present disclosure may be applied to a natural language processing algorithm and software development industry using artificial intelligence models, the artificial intelligence chatbot service industry, and so on.

What is claimed is:

1. A text semantic analysis method using source code analysis based on a communication connection between a terminal and a server, the text semantic analysis method comprising:
receiving, by the server, input data including a text from the terminal;
generating, by the server, a text analysis result including semantics of the text by performing natural language processing on the text based on the input data; and
generating, by the server, output data corresponding to the semantics of the text based on the text analysis result and providing the output data to the terminal,
wherein the generating of the text analysis result comprises modifying, by the server, the text by converting a text keyword into source code information corresponding to the text keyword when the text keyword including one or more words included in the text has semantics corresponding to the source code information stored in the server, and generating, by the server, the text analysis result by performing analysis on the modified text.

2. The text semantic analysis method of claim 1, wherein
the server includes a memory storing the source code information including information on one or more programming languages, and
the source code information includes variable information, class information, function information, and relationship information thereof which are used for the one or more programming languages.

3. The text semantic analysis method of claim 2, further comprising:
storing the source code information in which the server generates the source code information and stores the source code information in the memory,
wherein the storing of the source code information comprises:
extracting nouns included in the variable information, the class information, and the function information which are used for the one or more programming languages and setting the extracted nouns as source code keywords by using the server; and
generating the source code information based on names of source codes corresponding to the source code keywords, abbreviations of the source codes, and relationships between translations of the source codes and the source code keywords and storing the source code information in the memory by using the server.

4. The text semantic analysis method of claim 3, wherein the generating of the text analysis result comprises:
determining, by the server, whether a source code keyword corresponding to the text keyword is in the memory; and
performing, by the server, semantic analysis on a text keyword including a corresponding source code keyword stored in the memory among the text keywords included in the text based on semantics of the corresponding source code keyword, and performing, by the server, semantic analysis on a text keyword which does not include a corresponding source code keyword based on dictionary semantics.

5. The text semantic analysis method of claim 1, wherein
the generating of the text analysis result comprises analyzing intent of the text, and analyzing an entity of the text,
the analyzing of the intent of the text comprises setting, by the server, the intent of the text to one of preset intent types based on the text analysis result including the semantics of the text, and
the analyzing of the entity of the text comprises setting, by the server, the entity of the text to one of preset entity types based on the text analysis result including the semantics of the text.

6. The text semantic analysis method of claim 5, wherein
the preset intent types include a function check type and an error report type, and
the preset entity types include a function description type and an error description type.

7. The text semantic analysis method of claim 2, wherein
the text includes question information,
the text analysis result includes function information for generating an answer corresponding to the question information of the text, and
the output data includes answer information generated according to the function information.

8. The text semantic analysis method of claim 2, wherein the generating of the text analysis result comprises:
providing, by the server, a plurality of pieces of source code information to the terminal when the text keyword including the one or more words included in the text has semantics corresponding to the plurality of pieces of source code information stored in the server; and
receiving an input for one piece of source code information among the plurality of pieces of source code information from the terminal, converting the text keyword into the source code information received from the terminal, modifying the text, analyzing the modified text, and generating the text analysis result by using the server.

9. A question-answer service providing method using source code analysis and a chatbot based on a communication connection between a terminal and a server, the question-answer service providing method comprising:
receiving, by the server, question data including a text from the terminal by using the chatbot;
performing, by the server, natural language processing on the text based on the question data by using the chatbot and generating, by the server, a text analysis result including semantics of the text; and
generating, by the server, answer data corresponding to the semantics of the text based on the text analysis result by using the chatbot and providing the answer data to the terminal,
wherein the performing of the natural language processing comprises modifying, by the server, the text by converting a text keyword into source code information corresponding to the text keyword by using the chatbot when the text keyword including one or more words included in the text has semantics corresponding to the source code information stored in the server, and generating, by the server, the text analysis result by performing analysis on the modified text by using the chatbot.

10. The question-answer service providing method of claim 9, wherein
the server includes a memory storing the source code information including information on one or more programming languages, and
the source code information includes variable information, class information, function information, and relationship information thereof which are used for the one or more programming languages.

11. The question-answer service providing method of claim 10, further comprising:
storing the source code information in which the server generates the source code information and stores the source code information in the memory,
wherein the storing of the source code information comprises:
extracting nouns included in the variable information, the class information, and the function information which are used for the one or more programming languages and setting the extracted nouns as source code keywords by using the server; and
generating the source code information based on names of source codes corresponding to the source code keywords, abbreviations of the source codes, and a relationship between translations of the source codes and the source code keywords and storing the source code information in the memory by using the server.

12. The question-answer service providing method of claim 11, wherein the performing of the natural language processing comprises:
determining, by the server, whether a source code keyword corresponding to the text keyword is in the memory; and
performing, by the server, semantic analysis on a text keyword including a corresponding source code keyword stored in the memory among the text keywords included in the text based on semantics of the corresponding source code keyword, and performing, by the server, semantic analysis on a text keyword which does not include a corresponding source code keyword based on dictionary semantics.

13. The question-answer service providing method of claim 9, wherein
the performing of the natural language processing comprises analyzing intent of the text, and analyzing an entity of the text,
the analyzing of the intent of the text comprises setting, by the server, the intent of the text to one of preset intent types based on the text analysis result including the semantics of the text, and
the analyzing of the entity of the text comprises setting, by the server, the entity of the text to one of preset entity types based on the text analysis result including the semantics of the text.

14. The question-answer service providing method of claim 10, wherein the performing of the natural language processing comprises:
providing, by the server, a plurality of pieces of source code information to the terminal by using the chatbot when the text keyword including the one or more words included in the text has semantics corresponding to the plurality of pieces of source code information stored in the server; and
receiving an input for one piece of source code information among the plurality of pieces of source code information from the terminal, converting the text keyword into the source code information received from the terminal, modifying the text, analyzing the modified text, and generating the text analysis result, which are performed by the server by using the chatbot.

15. A text semantic analysis system using source code analysis through a communication connection to a terminal, the text semantic analysis system comprising:
a communication module configured to transmit and receive information to and from the terminal;
a memory storing a text semantics analysis program; and
a processor configured to execute a text semantics analysis program stored in the memory,
wherein, by executing the text semantics analysis program, the processor receives input data including a text from the terminal through the communication module, generates a text analysis result including semantics of the text by performing natural language processing on the text based on the input data, generates output data corresponding to the semantics of the text based on the text analysis result, and provides the output data to the terminal, and
when the text keyword including one or more words included in the text has semantics corresponding to the source code information stored in the memory, the processor modifies the text by converting a text keyword into source code information corresponding to the text keyword and generates the text analysis result by performing analysis on the modified text.

16. The text semantic analysis system of claim 15, wherein
the memory includes the source code information including information on one or more programming languages, and
the source code information includes variable information, class information, function information, and relationship information thereof which are used for the one or more programming languages.

17. The text semantic analysis system of claim 16, wherein by executing the text semantics analysis program, the processor extracts nouns included in the variable information, the class information, and the function information which are used in the one or more programming languages, sets the nouns as source code keywords, generates the source code information based on names of source codes corresponding to the source code keywords, abbreviations of the source codes, and relationships between translations of the source codes and the source code keywords, and stores the source code information in the memory.

18. The text semantic analysis system of claim 17, wherein by executing the text semantics analysis program, the processor determines whether a source code keyword corresponding to the text keyword is in the memory, performs semantic analysis on a text keyword including a corresponding source code keyword stored in the memory among the text keywords included in the text based on semantics of the corresponding source code keyword, and performs semantic analysis on a text keyword which does not include a corresponding source code keyword based on dictionary semantics.

19. The text semantic analysis system of claim 15, wherein by executing the text semantics analysis program, the processor sets the intent of the text to one of preset intent types based on the text analysis result including the semantics of the text, and sets the entity of the text to one of preset entity types based on the text analysis result including the semantics of the text.

20. The text semantic analysis system of claim 16, wherein by executing the text semantics analysis program, when the text keyword including the one or more words included in the text has semantics corresponding to a plurality of pieces of source code information stored in the memory, the processor further performs a function of providing the plurality of pieces of source code information to the terminal, receiving an input for one piece of source code information among the plurality of pieces of source code information from the terminal, modifying the text by converting the text keyword into source code information received from the terminal, performing analysis on the modified text, and generating the text analysis result.

21. A text semantic analysis device using source code analysis, the text semantic analysis device comprising:
an input/output module;
a memory storing a text semantics extraction program; and
a processor configured to execute a text semantics extraction program stored in the memory,
wherein by executing the text semantics extraction program, the processor receives input data including a text through the input/output module, generates a text analysis result including semantics of the text by performing natural language processing on the text based on the input data, generates output data corresponding to the semantics of the text based on the text analysis result, and displays the output data on the input/output module, and
when the text keyword including one or more words included in the text has semantics corresponding to the source code information stored in the memory, the processor modifies the text by converting a text keyword into source code information corresponding to the text keyword and generates the text analysis result by performing analysis on the modified text.

22. The text meaning analysis device of claim 21, wherein
the memory includes the source code information including information on one or more programming languages, and
the source code information includes variable information, class information, function information, and relationship information thereof which are used for the one or more programming languages.

23. The text meaning analysis device of claim 22, wherein by executing the text semantics extraction program, the processor further performs a function of extracting nouns included in the variable information, the class information, and the function information which are used in the one or more programming languages, setting the nouns as source code keywords, generating the source code information based on names of source codes corresponding to the source code keywords, abbreviations of the source codes, and relationships between translations of the source codes and the source code keywords, and storing the source code information in the memory.

24. The text meaning analysis device of claim 23, wherein by executing the text semantics extraction program, the processor further performs a function of determining whether a source code keyword corresponding to the text keyword is in the memory, performing semantic analysis on a text keyword including a corresponding source code keyword stored in the memory among the text keywords included in the text based on semantics of the corresponding source code keyword, and performing semantic analysis on a text keyword which does not include a corresponding source code keyword based on dictionary semantics.

25. The text meaning analysis device of claim 21, wherein by executing the text semantics extraction program, the processor further performs a function of setting the intent of the text to one of preset intent types based on the text analysis result including the semantics of the text and setting the entity of the text to one of preset entity types based on the text analysis result including the semantics of the text.

26. The text meaning analysis device of claim 22, wherein by executing the text semantics extraction program, when the text keyword including the one or more words included in the text has semantics corresponding to a plurality of pieces of source code information stored in the memory, the processor further performs a function of displaying the plurality of pieces of source code information on the input/output module, receiving an input for one piece of source code information among the plurality of pieces of source code information through the input/output module, modifying the text by converting the text keyword into the received source code information, performing analysis on the modified text, and generating the text analysis result.

27. A non-transitory computer-readable recording medium on which a computer program for performing the text semantics analysis method using the source code analysis according to claim 1 is recorded.
